(19) United States
(12) Patent Application Publication
(10) Pub. No.: US 2007/0189239 A1
(43) Pub. Date: Aug. 16, 2007

(54) System and method for transmitting uplink data in a broadband wireless communication system

(75) Inventors: Se-Youn Lim, Seoul (KR); Young-Jun Park, Seoul (KR); Joo-Han Song, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 11/654,176

(22) Filed: Jan. 17, 2007

(30) Foreign Application Priority Data
Jan. 17, 2006 (KR) 4991-2006

(51) Int. Cl. H04B 7/212

(52) U.S. Cl. 370/337

(57) ABSTRACT

An uplink packet data transmission system and method are provided which can reduce a collision probability in a contention period by assigning a priority to mobile stations when bandwidth allocation is rejected due to lack of resources of a base station from which a best effort service is provided. In a method for transmitting best effort data in a communication system, the base station allocates resources to mobile stations for which a reservation has been made in a previous time period when bandwidth for the mobile stations requesting bandwidth allocation is insufficient, reserves bandwidth for mobile stations for which the bandwidth allocation has been rejected, and transmits reservation information. The mobile stations receive the reservation information, skip a next scheduled bandwidth allocation request, and transmit data through bandwidth allocated from the base station.

### PRIORITY

This application claims the benefit under 35 U.S.C. § 119(a) of a Korean Patent Application filed in the Korean Intellectual Property Office on Jan. 17, 2006 and assigned Serial No. 2006-4991, the entire disclosure of which is incorporated herein by reference.

### BACKGROUND OF THE INVENTION

1. Field of the Invention

The present invention generally relates to a broadband wireless communication system, and more particularly to a system and method for effectively transmitting uplink packet data from a mobile station (MS) in a wireless communication system.

2. Description of the Related Art

Technology used to provide users with data services in current wireless communication environments are classified into 2.5^{th} or 3^{rd} generation cellular mobile communication technologies such as code division multiple access 2000 1× evolution data optimized (CDMA2000 1×EVDO), general packet radio services (GPRS) and universal mobile telecommunication service (UMTS), and wireless local area network (LAN) technology such as the Institute of Electrical and Electronics Engineers (IEEE) 802.11 wireless LAN.

A distinctive feature of the 3^{rd} generation cellular mobile communication technology for providing a voice service via a circuit network is that packet data services are provided to subscribers for accessing the Internet in a broad wireless communication environment.

With the development of the mobile communication technology, various LAN wireless access technologies such as an IEEE 802.16 based wireless LAN, Bluetooth, and the like are appearing. These technologies do not provide for a mobility level equal to that of a cellular mobile communication system. However, the LAN wireless access technologies are being proposed as an alternative plan for providing a high-speed data service in a wireless environment by replacing a wired communication network such as a cable modem or digital subscriber line (xDSL) with a wireless LAN in a home network environment or a hot spot area such as a public place or a school.

When the above-described wireless LAN provides the high-speed data service, there are limitations in providing users with public network services due to the propagation of interference as well as a very limited mobility and a narrow service coverage area.

Thus various efforts are being made to overcome these limitations. For example, extensive research is being conducted on broadband wireless communication systems for making up for the weak points of the cellular mobile communication system and the wireless LAN. The standardization and development of the broadband wireless communication systems are actively ongoing. The broadband wireless communication systems can provide a high-speed data service using various types of mobile stations (MSs) in indoor/outdoor stationary environments and mobile environments at pedestrian speed and medium/low speed (of about 60 Km/h).

On the other hand, the broadband wireless communication system is a technology capable of receiving wireless data at a high rate while moving at high speeds. Moreover, the broadband wireless communication system basically provides quality of service (QoS). That is, various types of QoS parameters such as transmission bandwidth and the like differ according to service provided from a higher layer of the broadband wireless communication system.

In other words, a characteristic of a physical medium such as a data transmission rate may rapidly vary according to the characteristics and environment of a wireless medium in the broadband wireless communication system different from a wired network. It is impossible to predict the characteristic variation. This may not cause a large problem when a service such as an Internet search is used, but may cause service degradation due to delay and jitter in the case of a multimedia service such as motion pictures. In the case of a service requiring a guaranteed bandwidth, significant service degradation can be caused in terms of QoS. Since the user demand for multimedia has substantially increased with the development of the network environments, QoS guarantee should be considered when a communication system is developed.

A method for transmitting uplink packet data from an MS to a BS in the above-described broadband wireless communication system will be described.

First, polling methods defined in the broadband wireless communication system are unicast, multicast and broadcast polling methods and the like. In the broadband wireless communication system, five service types are defined by the polling methods. The five service types are an unsolicited grant service (UGS), real-time polling service (rtPS), extended real-time polling service (ertPS), non-real-time polling service (nrtPS) and best effort service (BES). The service types will be described below.

A non-real-time service of scheduling services, for example, the BES, will be described in detail.

FIG. 1 illustrates a BES procedure in the conventional broadband wireless communication system.

Referring to FIG. 1, a base station (BS) 130 transmits a broadcast polling signal (step 101). In response to the broadcast polling signal, one or more MSs, for example, an MS 110, for transmitting data sends a bandwidth allocation request to the BS 130 (step 103). The bandwidth allocation request is made on a contention basis.

All MSs for receiving the BES receive the broadcast polling signal from the BS 130. Thus all the MSs simultaneously contend for receiving the broadcast service.

Uplink bandwidth cannot be allocated to MSs that fail in the contention process between the MSs for the BES. The MSs that fail in the contention process suffer from delay. For this reason, a best effort scheme is conventionally used for best effort packet data transmission.

Upon the success in the contention process with other MSs receiving the broadcast polling signal from the BS 130, the MS 110 sets a data transmission time and then transmits data to the BS 130.

The BS 130 unicasts a data grant burst type information element (IE) to an MS(s), for example, the MS 110, successfully requesting the bandwidth allocation without a collision according to successful contention (step 105). Then the MS 110 provides the BS 130 with data in a position defined in the IE. Herein, the data grant burst type IE is included and transmitted in an uplink MAP (UL MAP).

The BES procedure as illustrated in FIG. 1 is an ideal case. Many collisions may occur in the wireless communication system. This case will be described with reference to FIG. 2.

FIG. 2 illustrates a BES procedure according to collision occurrence in the conventional broadband wireless communication system.

An example of the BES procedure when a bandwidth allocation request transmitted from an MS collides with those of other neighbor MSs will be described with reference to FIG. 2.

Referring to FIG. 2, a BS 230 transmits a broadcast polling signal (step 201). In response to the broadcast polling signal, one or more MSs for transmitting data, for example, an MS 210 provides the BS 230 with a bandwidth allocation request in a current cycle, for example, the N-th cycle (step 203). Then the MS 210 waits for a data grant burst type IE to be received from the BS 230 in the next cycle, for example, the (N+1)-th cycle.

When the data grant burst type IE is not received from the BS 230 during the (N+1)-th cycle, the MS 210 determines that the bandwidth allocation request message has collided with other messages and then starts a contention process.

When the MS 210 receives a best effort polling signal from the BS in the M-th cycle after a predefined backoff time, the bandwidth allocation request message is retransmitted on a contention basis (step 205). The MS 210 waits for a data grant burst type IE to be received from the BS 230 in the (M+1)-th cycle. When receiving the data grant burst type IE from the BS 230 (step 207), the MS 210 transmits data in a position defined in the IE to the BS 230 (step 209).

As described above, when the MS does not receive the data grant burst type IE from the BS during a predefined time after transmitting the bandwidth allocation request message, the bandwidth allocation request message is retransmitted if the best effort polling signal is received from the BS after the backoff time. At this time, the MS determines that the bandwidth allocation request message has collided with other messages and then starts the contention process. Then the MS retransmits the bandwidth allocation request message after the backoff time according to the contention result. However, in this case, the following problem may occur in the broadband wireless communication system.

If the bandwidth for the BES in the BS is insufficient, even when the MS successfully transmits the bandwidth allocation request message to the BS, the bandwidth allocation request of the MS may be rejected. In this case, the MS does not receive the data grant burst type IE from the BS. Thus the MS starts the contention process as described above and then retransmits the bandwidth allocation request message after the backoff time.

When a collision occurs upon second retransmission, the MS retransmits the bandwidth allocation request. If the data grant burst type IE is successfully received from the BS, data is transmitted.

In the above-described scheme, all of the MSs simultaneously request the bandwidth allocation regardless of the uplink bandwidth currently available in the BS. Consequently, a lager number of MSs may fail in the contention process. In the broadband wireless communication system, the MSs that fail in the contention process attempt to send the bandwidth allocation request to the BS after an arbitrary time has elapsed. In this case, there is a problem in that the delay may increase in the uplinks of the MSs.

As described above, if the bandwidth cannot be allocated to the MS because of lack of resources of the BS even when the MS successfully transmits the bandwidth allocation request message, the associated MS makes an attempt for retransmission. In this case, as the number of other MSs contending with the associated MS in the next contention period increases, a collision probability increases. There is a problem in that a transmission priority may be low when the bandwidth allocation request has failed in the next contention period.

Thus a need exists for a scheme for increasing the efficiency of bandwidth allocation for a non-real-time service, for example, the BES, when an MS transmits uplink packet data to a BS.

### SUMMARY OF THE INVENTION

An aspect of the present invention is to address at least the above problems and/or disadvantages and to provide at least the advantages described below. Accordingly, an aspect of the present invention is to provide a scheme that can efficiently transmit uplink packet data between a mobile station and a base station in a broadband wireless communication system.

Another aspect of the present invention is to provide a scheme that can increase the efficiency of bandwidth allocation for best effort traffic in a broadband wireless communication system.

A further aspect of the present invention is to provide an uplink packet data transmission scheme that can enable mobile stations for receiving a best effort service to reduce a collision probability in a contention period when a base station rejects a bandwidth allocation in a broadband wireless communication system.

A still further aspect of the present invention is to provide a scheme that can reduce a transmission delay of best effort traffic by reducing a collision probability between bandwidth allocation requests of mobile stations in a broadband wireless communication system.

In accordance with an aspect of the present invention, there is provided a method for transmitting best effort data in a communication system, including allocating, by a base station, resources to mobile stations for which a reservation has been made at a previous time when bandwidth for the mobile stations requesting bandwidth allocation is insufficient, reserving bandwidth for mobile stations for which the bandwidth allocation has been rejected, and transmitting reservation information; and receiving, by the mobile stations, the reservation information, skipping a next scheduled bandwidth allocation request, and transmitting data through bandwidth allocated from the base station.

In accordance with another aspect of the present invention, there is provided a method for providing a best effort service in a communication system, including allocating bandwidth from a base station to mobile stations which have not received bandwidth allocation at a previous time when bandwidth for the mobile stations requesting the bandwidth allocation is insufficient; reserving bandwidth based on a priority when there are mobile stations for which the bandwidth allocation has been rejected; and transmitting reservation information to the mobile stations for which the bandwidth allocation has been rejected.

In accordance with a further aspect of the present invention, there is provided a method for transmitting best effort data in a communication system, including transmitting a bandwidth allocation request when receiving from a base station a broadcast polling signal; checking response information when the response information to the bandwidth allocation request is received; waiting for bandwidth to be allocated from the base station when the response information includes reservation information; and transmitting data mapped to the response information when the response information does not include the reservation information.

In accordance with a still further aspect of the present invention, there is provided a system for transmitting best effort data in a communication system, including a base station for allocating resources to mobile stations for which a reservation has been made at a previous time when bandwidth for the mobile stations requesting bandwidth allocation is insufficient, reserving bandwidth for mobile stations for which the bandwidth allocation has been rejected, and transmitting reservation information; and the mobile stations each receiving from the base station bandwidth allocation information and the reservation information, skipping a next scheduled bandwidth allocation request according to the reservation information, and transmitting data through bandwidth allocated from the base station.

### BRIEF DESCRIPTION OF THE DRAWINGS

The above and other features and advantages of the present invention will be more apparent from the following detailed description taken in conjunction with the accompanying drawings, in which:

FIG. 1 illustrates a best effort service (BES) procedure in a conventional broadband wireless communication system;

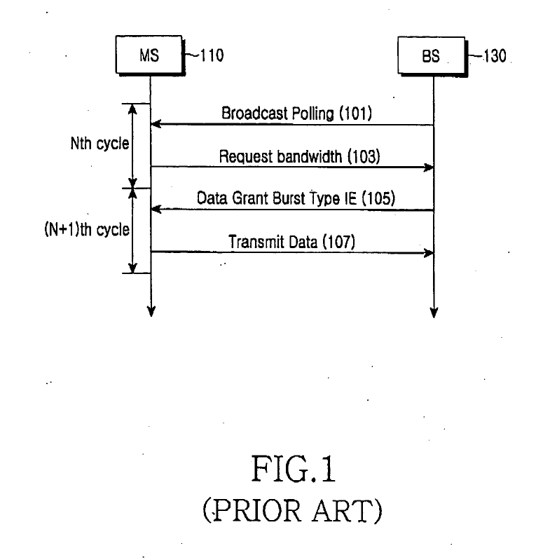

FIG. 2 illustrates a BES procedure according to collision occurrence in the conventional broadband wireless communication system;

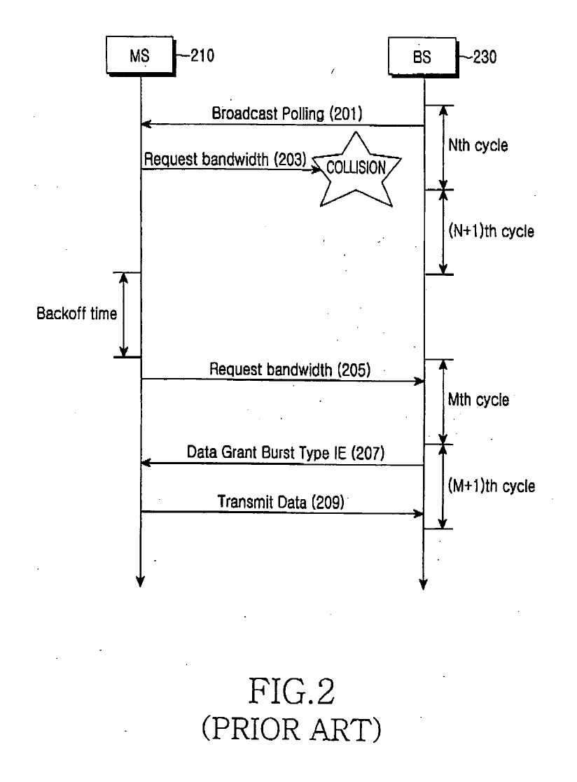

FIG. 3 illustrates an operation process of a base station (BS) in a wireless communication system in accordance with the present invention;

FIG. 4 illustrates a data transmission process of a mobile station (MS) in the wireless communication system in accordance with the present invention; and

FIG. 5 illustrates a BES procedure between an MS(s) and a BS in the wireless communication system in accordance with the present invention.

### DETAILED DESCRIPTION OF PREFERRED EMBODIMENTS

The matters defined in the description such as a detailed construction and elements are provided to assist in a comprehensive understanding of preferred embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides a scheme for efficiently transmitting uplink (UL) packet data between a mobile station (MS) and a base station (BS) in a broadband wireless communication system. In particular, the present invention provides a scheme that can reduce a collision probability in a contention period when an MS requests bandwidth allocation to transmit best effort traffic and therefore can increase the efficiency of bandwidth allocation.

In the present invention, when a bandwidth allocation is rejected for an MS for receiving a best effort service (BES) due to insufficient or a lack of resources of the BS, a priority can be assigned to the associated MS. The MS skips a next scheduled bandwidth allocation request procedure, thereby reducing a collision probability in a contention period. Moreover, the efficiency of bandwidth use of each MS can increase and the transmission delay of best effort traffic can decrease.

Conventionally, a broadband wireless communication system, for example, an Institute of Electrical and Electronics Engineers (IEEE) 802.16 system, defines five types of UL data transmission scheduling, that is, as an unsolicited grant service (UGS), real-time polling service (rtPS), extended real-time polling service (ertPS), non-real-time polling service (nrtPS) and best effort service (BES).

The five types of UL data transmission scheduling defined in the broadband wireless communication system and data transmission methods of an MS based on the scheduling will be described.

The UGS periodically allocates a fixed size UL bandwidth whose delay is guaranteed from the BS to the MS. When a connection between the MS and the BS is established for the UGS, the BS allocates the UL bandwidth to the MS until the connection is released without a special signaling process.

The rtPS periodically allocates a variable size UL bandwidth whose delay is guaranteed from the BS to the MS. A UL bandwidth allocation procedure for the rtPS is as follows.

The BS transmits a unicast polling signal to a selected MS for receiving the rtPS through downlink (DL). When receiving the unicast polling signal from the BS, the MS transmits a bandwidth request to the BS through UL. When receiving the bandwidth request from the MS, the BS allocates the UL bandwidth requested by the MS through the DL if the bandwidth requested by the MS is available.

The ertPS periodically allocates a variable size UL bandwidth whose delay is guaranteed from the BS to the MS. A UL bandwidth allocation procedure for the ertPS is performed like that for the rtPS.

The nrtPS periodically allocates a variable size UL bandwidth whose delay is not guaranteed from the BS to the MS. A UL bandwidth allocation procedure for the nrtPS is as follows.

The BS transmits a multicast polling signal to selected MSs for receiving the rtPS through the DL. When receiving the multicast polling signal from the BS, all of the MS simultaneously transmit bandwidth requests to the BS through the UL. When receiving the multicast polling signal from the BS, all of the MSs contend for the UL bandwidth. Then the BS allocates the UL bandwidth requested by the MSs succeeded in the contention process through the DL.

The BES periodically allocates a variable size UL bandwidth whose delay is not guaranteed from the BS to the MS. A UL bandwidth allocation procedure for the BES is as follows.

The BS transmits a broadcast polling signal to MSs for receiving the BES through the DL. When receiving the broadcast polling signal from the BS, all of the MS simultaneously transmit bandwidth requests to the BS through the UL. When receiving the broadcast polling signal from the BS, all of the MSs contend for the UL bandwidth. Then the BS allocates the UL bandwidth requested by MSs succeeded in the contention process through the DL.

In the broadband wireless communication system as described above, the non-real-time service, for example, the nrtPS or BES, is defined such that all MSs using the associated service can simultaneously transmit bandwidth requests in relation to multicast or broadcast polling.

All of the MSs simultaneously request the bandwidth regardless of the UL bandwidth currently available in the BS. Consequently, a greater number of MSs may fail in the contention process or may not receive bandwidth allocation. When each MS, which has failed in the contention process or has not received the bandwidth allocation, retransmits the bandwidth request to the BS after an arbitrary time has elapsed. Thus there is a problem in that delay increases in the UL of the MSs.

When the MSs for receiving the BES request the bandwidth allocation in the present invention, the BS determines if the requested bandwidth is available. Then the BS transmits information based on a determination result to the associated MSs, thereby reducing a collision probability in a contention period and reducing the delay due to the bandwidth allocation requests retransmitted from the MSs.

As described above, a bandwidth allocation request message for the BES is conventionally transmitted on a contention basis. The bandwidth allocation may be rejected due to a lack of resources of the BS even when the bandwidth allocation request message is successfully transmitted. In this case, the MS restarts a bandwidth allocation request procedure. No guarantee is provided even when the procedure is restarted. Thus a repeated error may occur in the MS. As the MS considers the lack of resources as the collision, retransmission is performed after a backoff time and therefore delay occurs.

In the present invention, a priority is assigned to MSs for which the bandwidth allocation has been rejected due to the lack of resources. A procedure for retransmitting the bandwidth allocation request message on the contention basis is skipped. Through this, a scheme is provided which can reduce a collision probability in the contention period of the next cycle.

In the present invention comprise provided a BS for providing a broadband wireless data service and an MS for receiving the service from the BS.

The BS transmits a polling signal to the MS for a specific scheduling service. When receiving a bandwidth allocation request from the MS, the BS performs UL scheduling and provides the associated MS with bandwidth allocation or priority information, for example reservation information, for the next cycle.

The MS receives a polling signal of the associated scheduling service from the BS. When data to be transmitted is present, the MS transmits a bandwidth allocation request message to the BS. When the bandwidth is allocated from the BS, the data is transmitted. However, when the bandwidth is not allocated from the BS, the MS transmits the data by receiving the bandwidth allocation according to priority based on the priority information in the next cycle after an arbitrary time has elapsed according to system setting.

In the present invention, the BS can preferably include a reservation management processor for managing a reservation for MSs for which the bandwidth allocation has been rejected due to a lack of resources and a reservation information generator for reporting the presence of a reservation. The reservation information generator generates and transmits a reserved grant IE.

The reservation management processor manages MSs incapable of receiving bandwidth allocation due to the lack of resources of the BS among MSs succeeded in requesting the bandwidth allocation. The processor reports the presence of MSs for which the reservation is made upon bandwidth allocation and manages MSs for which the reservation is newly made after processing the bandwidth allocation.

The BS reports a bandwidth allocation result in a grant signal. The BS transmits a data grant burst type IE for reporting successful bandwidth allocation to each MS capable of receiving the bandwidth allocation. The BS transmits a reserved grant IE to report the reservation to MSs for which the reservation has been made for the bandwidth allocation in the next cycle.

When receiving the reserved grant IE from the BS after transmitting the bandwidth allocation request, the MS detects that the bandwidth allocation has been rejected due to the lack of resource and has been reserved for the next cycle. Thus the MS transmits data when receiving the data grant burst type IE without retransmitting the bandwidth allocation request in the next cycle.

The above-described operation in accordance with the present invention will be described in detail with reference to the accompanying drawings.

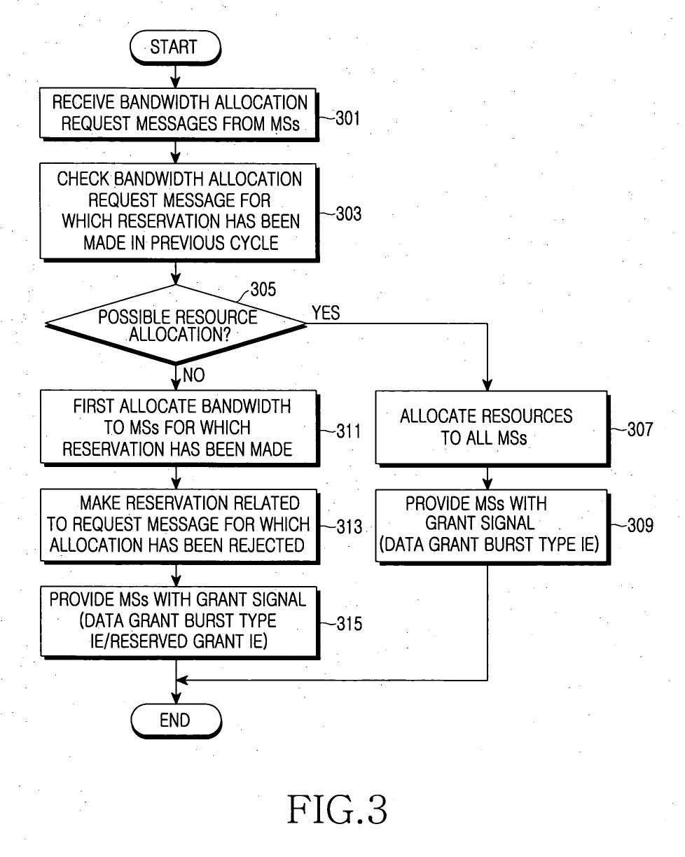

FIG. 3 illustrates an operation process of the BS in a wireless communication system in accordance with the present invention.

Referring to FIG. 3, in step 301 the BS receives bandwidth allocation request messages from MSs. In step 303 the BS determines whether there is an MS for which the bandwidth allocation is reserved for a current cycle, for example, the N-th cycle, after the bandwidth allocation is rejected in a previous cycle, for example, the (N−1)-th cycle, due to lack of resources.

In step 305, the BS compares bandwidth newly requested in the N-th cycle, bandwidth reserved for the (N−1)-th cycle and a size of resources capable of being allocated currently, that is, in the N-th cycle. Then the BS determines if resources are assignable to the MSs. The BS proceeds to step 307 or 311 according to the determination result.

If resource allocation is determined in step 305 to be possible for both the currently requested bandwidth and the bandwidth reserved in the previous cycle, the BS proceeds to step 307 to allocate the bandwidth to all the MSs requesting the bandwidth allocation. In step 309, the BS notifies the associated MSs of the bandwidth allocation result through the data grant burst type IE after allocating the bandwidth to all the MSs.

If the resource allocation is impossible for the currently requested bandwidth and the bandwidth reserved in the previous cycle, that is, resources are lacking, as the determination result of step 305, the BS proceeds to step 311 to first allocate the bandwidth to MSs for which the reservation has been made in the previous cycle, that is, the (N−1)-th cycle. In step 311, the remaining resources are adaptively or dividedly allocated to requesting MSs in the N-th cycle after allocating the bandwidth requested in the (N−1)-th cycle.

In step 313, the BS makes a reservation such that bandwidth allocation is possible in the (N+1)-th cycle for MSs for which bandwidth allocation requested in the N-th cycle has been rejected due to lack of resources after allocating the bandwidth to the associated MSs. Preferably, the reservation can be stored in a reservation queue through the processor for managing the reservation for the MSs for which the bandwidth allocation has been rejected.

In step 315, the BS notifies the associated MSs of the bandwidth allocation result through a data grant burst type IE after allocating the bandwidth to the MSs. When the MSs have succeeded in requesting the bandwidth allocation but the reservation has been made for the (N+1)-th cycle due to lack of resources, the BS notifies the MSs that the reservation has been made for the bandwidth allocation of the (N+1)-th cycle through a reserved grant IE.

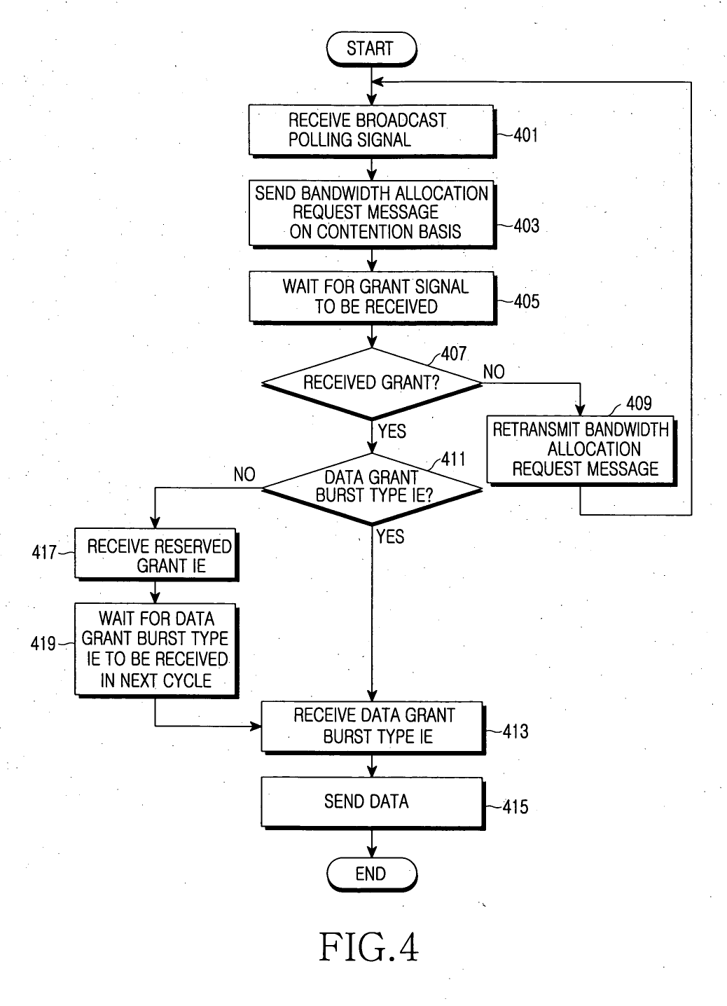

FIG. 4 illustrates a data transmission process of the MS in the wireless communication system in accordance with the present invention.

Referring to FIG. 4, in step 401 the MS receives a broadcast polling signal from a BS. In step 403 the MS transmits a bandwidth allocation request message for a BES to the BS on a contention basis in step 403 and then proceeds to step 405 to wait for a grant signal to be received from the BS.

When determining that the grant signal is not received from the BS during a predetermined time according to system setting in step 407 while waiting for the grant signal to be received in step 405, the MS proceeds to step 409. In step 409, the MS repeats a process for retransmitting the bandwidth allocation message after a backoff time as in a conventional scheme.

Upon determining that the grant signal is received from the BS in step 407 while waiting for the grant signal to be received in step 405, the MS proceeds to step 411 to determine a type of the received grant. That is, when the grant type is determined to be a data grant burst type IE in step 411, the MS proceeds to step 413 to receive the data grant burst type IE. When the grant type is determined to be a reserved grant IE in step 411, the MS proceeds to step 417 to receive the reserved grant IE.

When receiving the data grant burst type IE in step 413, the MS proceeds to step 415 to transmit data mapped to the data grant burst type IE to the BS.

When receiving the reserved grant IE in step 417, the MS detects that bandwidth allocation has been reserved for the next cycle, for example, the (N+1)-th cycle. In step 419, the MS waits for a data grant burst type IE of the next cycle to be received. When the data grant burst type IE is received in step 413, the MS proceeds to step 415 to transmit data to the BS.

When receiving the reserved grant IE from the BS as described above, the MS skips a process for transmitting the bandwidth allocation request message in the next cycle. In the present invention, the reserved grant IE can be included and transmitted in a UL MAP. That is, the reserved grant IE can be expressed as shown in Table 1, and can be added and transmitted in an uplink interval usage code (UIUC) field in a tuple form.

TABLE 1

| | | Connection | |
|---|---|---|---|
| IE name | UIUC | ID | Description |
| | 0 | N/A | reserved |
| Request | 1 | Any | Starting offset of request region |
| Initial | 2 | Broadcast | Starting offset of maintenance |
| Ranging | | | region(used in Initial Ranging) |
| | 3 | N/A | reserved |
| Data Grant | 4 | Unicast | Starting offset of Data Grant |
| Burst Type 1 | | | Burst Type 1 assignment |
| Data Grant | 5 | Unicast | Starting offset of Data Grant |
| Burst Type 2 | | | Burst Type 2 assignment |
| Data Grant | 6 | Unicast | Starting offset of Data Grant |
| Burst Type 3 | | | Burst Type 3 assignment |
| Data Grant | 7 | Unicast | Starting offset of Data Grant |
| Burst Type 4 | | | Burst Type 4 assignment |
| Data Grant | 8 | Unicast | Starting offset of Data Grant |
| Burst Type 5 | | | Burst Type 5 assignment |
| Data Grant | 9 | Unicast | Starting offset of Data Grant |
| Burst Type 6 | | | Burst Type 6 assignment |
| End of map | 10 | Zero | Ending offset of the previous |
| | | | grant. |
| | | | Indicates the first mini-slot |
| | | | after the end of the uplink |
| | | | allocation. |
| | | | The burst profile is well known |
| | | | and shall not be included in the |
| | | | UCD message. Used to bound the |
| | | | length of the last actual |
| | | | interval allocation. |
| Gap | 11 | Zero | Used to schedule gaps in |
| | | | transmission |
| | 12-14 | N/A | reserved |
| Extended | 15 | N/A | See 8.1.5.1.2.1. |

Table 1 shows an example applied according to UIUC values defined in the broadband wireless communication system in the present invention. As shown in Table 1, a data grant burst IE can be expressed by a UIUC value. A UIUC value of a reserved grant IE proposed in the present invention can use a reserved value other than the UIUC values defined in Table 1. For example, the UIUC value of 3 or 12-14 in Table 1 is a reserved UIUC value currently unused. In the present invention, the reserved grant IE can use a reserved value other than the UIUC values defined in Table 1.

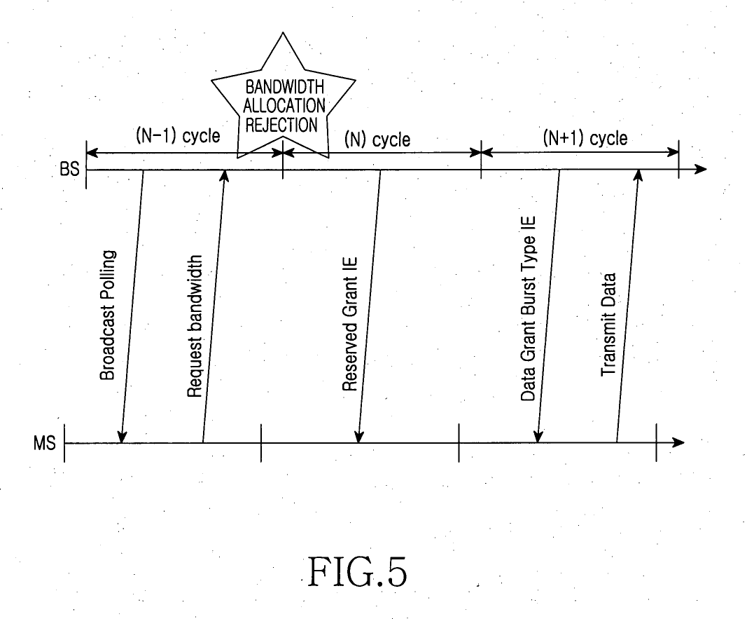

FIG. 5 illustrates a BES procedure between an MS(s) and a BS in the wireless communication system in accordance with the present invention.

FIG. 5 illustrates an example in which bandwidth allocation has been rejected due to lack of resources of the BS with respect to a bandwidth allocation request of an MS in a previous cycle, for example, the (N−1)-th cycle. FIG. 5 illustrates the case where the BS has not allocated bandwidth to MSs requesting the bandwidth allocation due to the lack of resources in the previous cycle.

Referring to FIG. 5, the MSs for data transmission send bandwidth allocation request messages to the BS in the (N−1)-th cycle when the BS transmits a broadcast polling signal in the (N−1)-th cycle.

In a current cycle, for example, the N-th cycle, the BS transmits a reserved grant IE to the associated MSs for which the bandwidth allocation has been rejected in the previous cycle. Upon receiving the reserved grant IE in the N-th cycle, the associated MSs wait for a data grant burst type IE to be received from the BS without requesting the bandwidth request in the current cycle, for example, the N-th cycle.

In the (N+1)-th cycle, the BS first transmits the data grant burst type IE to the associated MSs that have received the reserved grant IE in the N-th cycle. The associated MSs receive the bandwidth allocation earlier than MSs newly requesting the bandwidth allocation in the (N+1)-th cycle.

In a system and method for transmitting data in a broadband wireless communication system proposed in the present invention, BES data can be efficiently transmitted and received between a BS and an MS in the communication system. When bandwidth allocation to MSs for receiving the BES is rejected in the communication system, a priority is assigned to the associated MSs. At the next time, the bandwidth can be automatically allocated to the associated MSs according to priority.

The present invention can address the problem of unfair bandwidth allocation between MSs in the case where a service request process is restarted as the MSs have succeeded in bandwidth request contention process but have determined that a collision has occurred in contention process due to lack of resources. Moreover, the present invention can reduce a collision probability in a contention period in which the bandwidth allocation request is retransmitted from an MS.

The present invention can ensure the bandwidth allocation in the next cycle by assigning a priority based on a reservation for MSs that have succeeded in the bandwidth allocation request contention process but have not received the bandwidth allocation due to lack of resources. Thus fair bandwidth allocation is possible between the MSs. Since the MSs for which the reservation has been made do not need to contend for the bandwidth allocation requests, the probability of collision with other MSs can be reduced and therefore the BES can be efficiently provided.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for transmitting best effort data in a communication system, comprising:
allocating, by a base station, resources to mobile stations for which a reservation has been made at a previous time when bandwidth for the mobile stations requesting bandwidth allocation is insufficient, reserving bandwidth for mobile stations for which the bandwidth allocation has been rejected, and transmitting reservation information; and
receiving, by the mobile stations, the reservation information, skipping a next scheduled bandwidth allocation request, and transmitting data through bandwidth allocated from the base station.

2. The method of claim 1, further comprising:
determining, by the base station, if there is a mobile station for which a reservation for the bandwidth allocation has been made at the previous time period when receiving bandwidth allocation requests from the mobile stations;
determining, by the base station, assignable bandwidth for a current bandwidth allocation request and a request for the bandwidth allocation for which the reservation has been made at the previous time period;
allocating the bandwidth to all mobile stations currently requesting the bandwidth allocation and mobile stations for which the reservation has been made when bandwidth allocation for all the mobile stations is possible;
allocating the bandwidth to the mobile stations for which the reservation has been made when the bandwidth allocation for all the mobile stations is impossible;
reserving bandwidth by assigning a priority for the bandwidth allocation at the next time period to the mobile stations for which the bandwidth allocation has been rejected; and
transmitting bandwidth allocation information and the reservation information to associated mobile stations.

3. The method of claim 2, wherein transmitting the bandwidth allocation information and the reservation information comprises:
transmitting a data grant burst type information element (IE) to mobile stations for which the bandwidth allocation has been granted; and
transmitting a reserved grant IE to mobile stations for which the bandwidth allocation has been rejected, the reserved grant IE notifying that the bandwidth allocation for the next time period has been reserved.

4. The method of claim 1, further comprising:
transmitting, by the mobile stations, bandwidth allocation requests to the base station when receiving a broadcast polling signal from the base station;
checking a response message when the response message to a bandwidth allocation request is received;
transmitting data mapped to bandwidth allocation grant information when the response message includes the bandwidth allocation grant information; and
waiting for the bandwidth allocation grant information to be received at the next time period when the response message includes bandwidth allocation reservation information.

5. The method of claim 4, further comprising:
receiving, by the mobile stations, the reservation information, skipping the next scheduled bandwidth allocation request, and waiting for the bandwidth allocation grant information to be received; and
transmitting data in a position mapped to the bandwidth allocation grant information when receiving a response message including the bandwidth allocation grant information.

6. A method for providing a best effort service in a communication system, comprising:
allocating bandwidth from a base station to mobile stations which have not received bandwidth allocation in a previous time period when bandwidth for the mobile stations requesting the bandwidth allocation is insufficient;
reserving bandwidth based on a priority when there are mobile stations for which the bandwidth allocation has been rejected; and
transmitting reservation information to the mobile stations for which the bandwidth allocation has been rejected.

7. The method of claim 6, wherein allocating the bandwidth comprises:
determining if there is a mobile station for which the reservation for the bandwidth allocation has been made in the previous time period when receiving bandwidth allocation requests from the mobile stations;
determining if resources are available to mobile stations currently requesting the bandwidth allocation and mobile stations for which the reservation for the bandwidth allocation has been made in the previous time period;
allocating the bandwidth to all the mobile stations currently requesting the bandwidth allocation and the mobile stations for which the reservation has been made when bandwidth allocation for all the mobile stations is possible; and
allocating the bandwidth to, the mobile stations for which the reservation has been made in the previous time period when the bandwidth allocation for all the mobile stations is not possible.

8. The method of claim 6, wherein transmitting the reservation information comprises:
transmitting a data grant burst type information element (IE) to mobile stations for which the bandwidth allocation has been granted; and
transmitting a reserved grant IE to mobile stations for which the bandwidth allocation has been rejected, the reserved grant IE comprising reservation information of the bandwidth allocation in the next time period.

9. A method for transmitting best effort data in a communication system, comprising:
transmitting a bandwidth allocation request when receiving from a base station a broadcast polling signal;
checking response information when the response information to the bandwidth allocation request is received;
waiting for bandwidth to be allocated from the base station when the response information includes reservation information; and
transmitting data mapped to the response information when the response information does not include the reservation information.

10. The method of claim 9, further comprising:
receiving, by the mobile stations, the reservation information, skipping a next scheduled retransmission of the bandwidth allocation request, and waiting for bandwidth allocation grant information to be received; and
transmitting data in a position mapped to the bandwidth allocation grant information when receiving a response comprising the bandwidth allocation grant information.

11. A system for transmitting best effort data in a communication system, comprising:
a base station for allocating resources to mobile stations for which a reservation has been made in a previous time period when bandwidth for the mobile stations requesting bandwidth allocation is insufficient, reserving bandwidth for mobile stations for which the bandwidth allocation has been rejected, and transmitting reservation information; and

12. The system of claim 11, wherein the base station determines if there is a mobile station for which a reservation for the bandwidth allocation has been made in the previous time period when receiving bandwidth allocation requests from the mobile stations, determines if bandwidth is assignable for a current bandwidth allocation request and a request for the bandwidth allocation for which the reservation has been made in the previous time period, and allocates the bandwidth to all mobile stations currently requesting the bandwidth allocation and mobile stations for which the reservation has been made when bandwidth allocation for all the mobile stations is possible.

13. The system of claim 12, wherein the base station first allocates the bandwidth to the mobile stations for which the reservation has been made when the bandwidth allocation for all the mobile stations is not possible, reserves bandwidth by assigning a priority for the bandwidth allocation at the next time period to the mobile stations for which the bandwidth allocation has been rejected, and transmits the bandwidth allocation information and the reservation information to associated mobile stations.

14. The system of claim 12, wherein the base station transmits a data grant burst type information element (IE) to mobile stations for which the bandwidth allocation has been granted, and transmits a reserved grant IE to mobile stations for which the bandwidth allocation has been rejected, the reserved grant IE notifying that the bandwidth allocation for the next time period has been reserved.

15. The system of claim 11, wherein the base station comprises:
a processor for managing the reservation for the mobile stations for which the bandwidth allocation has been rejected; and
a reservation information generator for generating the reservation information indicating if the reservation has been made.

16. The system of claim 15, wherein the reservation information generator generates a data grant burst type information element (IE) for mobile stations for which the bandwidth allocation has been granted and generates a reserved grant IE for mobile stations for which the bandwidth allocation has been rejected, the reserved grant IE comprising reservation information of the bandwidth allocation for the next time period.

17. A system for transmitting best effort data in a communication system, comprising:
the mobile stations each receiving bandwidth allocation information and the reservation information from the base station, skipping a next scheduled bandwidth allocation request according to the reservation information, and transmitting data through bandwidth allocated from the base station.

18. The system of claim 17, wherein each of the mobile stations transmits a bandwidth allocation request to the base station when receiving a broadcast polling signal from the base station, checks a response when the response to the bandwidth allocation request is received, and transmits data mapped to bandwidth allocation grant information when the response comprises the bandwidth allocation grant information.

19. The system of claim 18, wherein each of the mobile stations waits for the bandwidth allocation grant information to be received in the next time period when the response comprises bandwidth allocation reservation information.

20. The system of claim 17, wherein each of the mobile stations receives the reservation information, skips a next scheduled retransmission of the bandwidth allocation request, waits for bandwidth allocation grant information to be received, and transmits data in a position mapped to the bandwidth allocation grant information when receiving a response includes the bandwidth allocation grant information while waiting for reception.
